(19) United States
(12) Patent Application Publication
(10) Pub. No.: US 2014/0034656 A1
(43) Pub. Date: Feb. 6, 2014

(54) Roof accessible wear panel for aggregate delivery unit

(71) Applicants: Cody Brunelle, (US); Cherrett Brunelle, (US)

(72) Inventors: Cody Brunelle, (US); Cherrett Brunelle, (US)

(21) Appl. No.: 13/507,870

(22) Filed: Aug. 3, 2012

(51) Int. Cl. B65D 90/06; B65D 90/62; B65G 69/00

(52) U.S. Cl. 220/601; 414/293; 220/729

(57) ABSTRACT

A housing for inspecting and replacing a wear plate maintained within the interior of the delivery unit compartment, along with a lift pipe guide to enable replacement of the lift pipe without entering the confined space compartment while also directing the proppant to precisely strike the wear plate and not the interior roof of the proppant compartment.

### BACKGROUND OF THE INVENTION

1. Field of the Invention

The present invention relates generally to improved access to the interior of a proppant delivery unit compartment and, in particular, to a housing for inspecting and replacing a wear plate maintained within the interior of the delivery unit compartment, along with a lift pipe guide to enable replacement of the lift pipe without entering the confined space compartment while also directing the proppant to precisely strike the wear plate and not the interior roof of the proppant compartment.

2. Description of Related Art

Hydraulic fracturing remains a key method of reservoir stimulation, providing a significant increase in oil and gas production. Fracturing is typically done by pumping a formation full of a fluid, which contains water and a solid particulate referred to as a proppant, often sand, and pressurizing that fluid in order to apply large surface forces to parts of the formation. These large surface forces cause stresses, and by virtue of the massive areas involved, can produce extremely high forces and stresses in the rock formations. Accordingly, the rock formations tend to shatter, increasing porosity an providing space for the production oil to pass through the formation toward the bore hole for extraction.

The proppant may be supplied from a proppant delivery unit located at the oilfield near the well. This unit is generally very large due to the amount of proppant that may be required for any given fracturing operation and, when loaded may be extremely heavy in weight. Thus, as a matter of practicality, the unit is provided to the wellsite location in a mobile but usually empty manner and then subsequently filled with a proppant of choice for the fracturing operation. In this manner, all of the proppant for the operation may be provided from a single controlled supply.

The proppant delivery unit includes separate compartments for housing potentially varying types of proppant or other additives for the operation. The compartments each include a fill port and lift pipe for filling the container with proppant, a hopper and valve assembly at the bottom thereof which may be individually controlled for emptying onto a conveyor belt leading to a mixer directed at the well.

The upper portion of the prior art compartments are essentially inaccessible. Secured to the underside of the top of the compartment is a wear plate. When proppant is pumped into the compartment through the fill port and lift pipe, the proppant strikes the wear plate and then falls to the lower interior portion of the compartment. In the prior art, the wear plate is constructed of metal. After successive strikes by the proppant, the wear plate and lift pipe begin to weaken thereby requiring a new wear plate and/or lift pipe to be installed. To remove and replace either the wear plate or lift pipe, an individual must enter the confined space of the compartment.

When entering the confined space of the compartment, the individual may be exposed to dust with high levels of respirable crystalline silica. On Jun. 21, 2012, the U.S. Department of Labor's Occupational Safety and Health Administration and the National Institute for Occupational Safety and Health issued a hazard alert on ensuring that employers in hydraulic fracturing operations take appropriate steps to protect workers from silica exposure.

Thus, there exists a need for a means for inspecting and replacing the wear plate and/or lift pipe within a proppant delivery unit without having to enter the compartment and being subjected to the harmful effects of the proppant.

### SUMMARY OF THE INVENTION

In light of the foregoing limitations, the present invention was conceived. In an exemplary embodiment of the present invention, there is disclosed a wear panel housing placed within an opening of the exterior roof wall of the proppant delivery unit. Maintained within the wear panel housing is a wear panel. To insure that the proppant strikes the wear panel, a lift pipe guide is removably attached to the lift pipe maintained within the interior of the compartment.

Through use of the wear panel housing, the wear panel can be inspected and replaced without entering the proppant compartment, thereby avoiding the negative health effects associated with confined space entry into the compartment. Likewise, through the use of the lift pipe guide, the lift pipe can be removed and replaced without having to enter the compartment and endanger the health of an individual.

Therefore, a general object of the present invention is to provide a means for inspecting the wear panel, lift pipe and compartment interior without the necessity of confined space entry.

A further objective of the present invention is to provide a wear panel with greater longevity so as to limit downtime of the proppant delivery unit.

It is the further object of the present invention to provide a means for easily and quickly accessing the interior of a proppant compartment.

It is the further object of the present invention to provide a lift pipe guide which enables the lift pipe to be removed and replaced from the exterior of the compartment while ensuring that the proppant is directed to the wear panel, thereby avoiding damage to the interior roof wall of the proppant compartment.

Certain embodiments of this invention are not limited to any particular individual feature disclosed here, but include combinations of them distinguished from the prior art in their structures, functions, and/or results achieved. Features of the invention have been broadly described so that the detailed descriptions that follow may be better understood, and in order that the contributions of this invention to the arts may be better appreciated. There are, of course, additional aspects of the invention described below and which may be included in the subject matter of the claims to this invention. Those skilled in the art who have the benefit of this invention, its teachings, and suggestions will appreciate that the conceptions of this disclosure may be used as a creative basis for designing other structures, methods and systems for carrying out and practicing the present invention. The claims of this invention are to be read to include any legally equivalent devices or methods which do not depart from the spirit and scope of the present invention.

The present invention recognizes and addresses the problems and needs in this area and provides a solution to those problems and a satisfactory meeting of those needs in its various possible embodiments and equivalents thereof. To one of skill in this art who has the benefits of this invention's realizations, teachings, disclosures, and suggestions, other purposes and advantages will be appreciated from the following description of certain preferred embodiments, given for the purpose of disclosure, when taken in conjunction with the accompanying drawings. The detail in these descriptions is not intended to thwart this patent's object to claim this invention no matter how others may later attempt to disguise it by variations in form, changes, or additions of further improvements.

The Abstract that is part hereof is to enable the U.S. Patent and Trademark Office and the public generally, and scientists, engineers, researchers, and practitioners in the art who are not familiar with patent terms or legal terms of phraseology to determine quickly from a cursory inspection or review the nature and general area of the disclosure of this invention. The Abstract is neither intended to define the invention, which is done by the claims, nor is it intended to be limiting of the scope of the invention in any way.

### BRIEF DESCRIPTION OF THE DRAWINGS

FIG. 1 is a side perspective view of the proppant delivery unit in accordance with the preferred embodiments of the present invention.

FIG. 2 is a top perspective view of the prior art exterior roof wall of a proppant delivery unit.

FIG. 3 is a side cross sectional view of the prior art proppant compartment of the proppant delivery unit.

FIG. 4 is a front perspective view of the lift pipe guide in accordance with the preferred embodiments of the present invention.

FIG. 5 is a side cross sectional view of the proppant compartment of the proppant delivery unit with a lift pipe guide attached to the lift pipe in accordance with the preferred embodiments of the present invention.

FIG. 6 is a perspective view of the wear panel housing, door, latch element, and hinge mechanism in accordance with the preferred embodiments of the present invention.

FIG. 7 is a top perspective view of the door and latch element in accordance with the preferred embodiments of the present invention.

FIG. 8 is a top perspective view of the exterior roof wall containing a wear panel housing with the lift pipe guide attached to the lift pipe in accordance with the preferred embodiments of the present invention.

FIG. 9 is a top perspective view of the exterior roof wall of a proppant delivery unit with doors to wear panel housings in accordance with the preferred embodiments of the present invention.

FIG. 10 is a bottom view of the wear panel housing's support plate and mounting lip in accordance with the preferred embodiments of the present invention.

FIG. 11 is a top perspective view of the pressure plate in accordance with the preferred embodiments of the present invention.

FIG. 12 is a side perspective view of the wear panel in accordance with the preferred embodiments of the present invention.

### DETAILED DESCRIPTION OF THE PREFERRED EMBODIMENTS

The present invention and the various features and advantageous details thereof are explained more fully with reference to the non-limiting embodiments described in the following description.

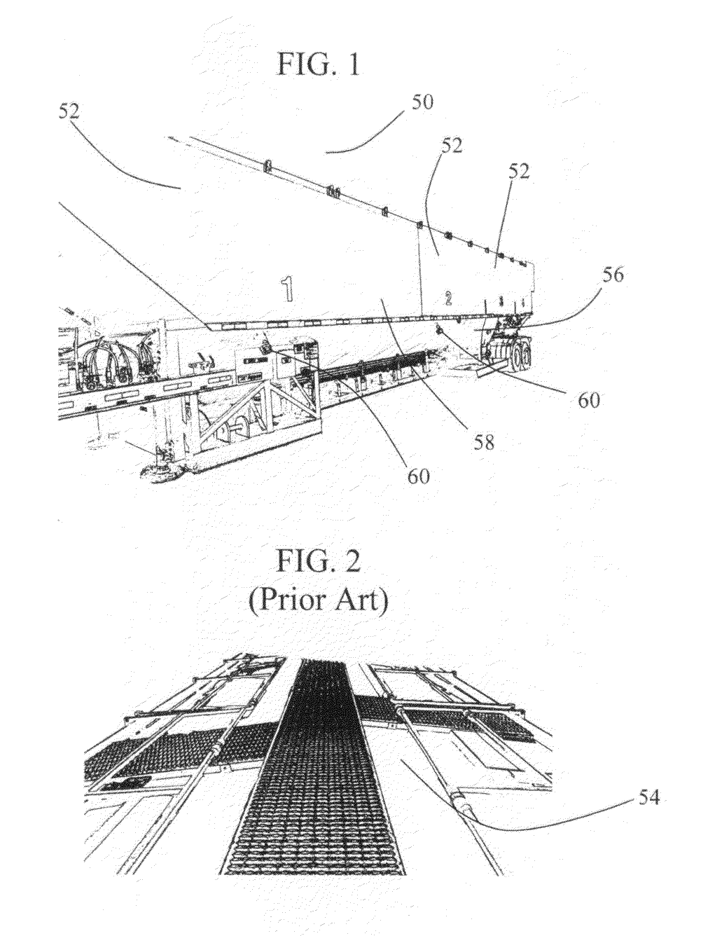

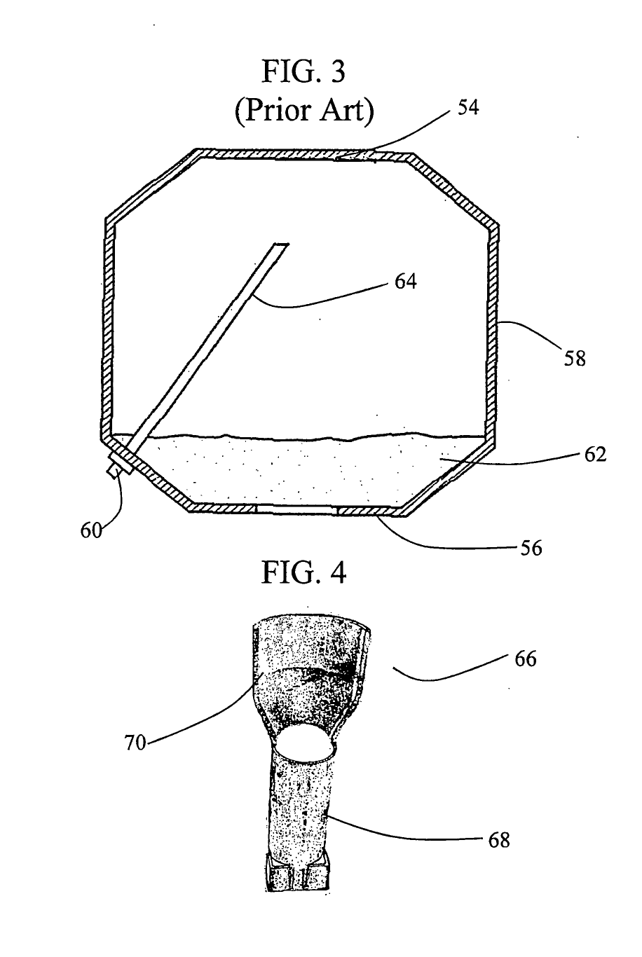

Referring to the figures, wherein like numerals indicate like or corresponding parts throughout the several views, FIG. 1 generally shows a proppant delivery unit (50). Maintained on the chasis of the proppant delivery unit are a plurality of proppant compartments (52). Each compartment (52) has a roof wall (54), bottom wall (56) and side walls (58).

As the proppant delivery unit (50) is commonly delivered to the well site empty, each compartment (52) is equipped with a fill port (60) for filling the compartments (52) with proppant (62). The fill port (60) is located at a lower portion of each compartment (52). The proppant (62) is pneumatically fed into the compartments (52) by conventional means, through the fill port (60).

Once the proppant (62) is fed into the compartment (52), the proppant (62) is dispensed through a lift pipe (64) toward the roof wall (54) of the compartment (52). As the lift pipe (64) is subject to wear from the proppant (62), a worn lift pipe (64) must be removed and replaced. The prior art replacement of a worn lift pipe (64) required removal of the worn lift pipe (64) through the fill port (60), insertion of a new lift pipe (64) through the fill port (60) with an individual inside of the compartment (52) to guide the lift pipe (64) to the proper position within the compartment (52). To eliminate the need for an individual to enter the confined space compartment (52), a lift pipe guide (66) is fixedly attached near the interior roof wall (54) of the compartment (52). Upon placement of the lift pipe guide (66), a worn lift pipe (64) is replaced by inserting the new lift pipe (64) into the fill port (60) until the lift pipe (64) comes into contact with and is inserted into the lift pipe guide (66). Once properly placed within the lift pipe guide (66), the lift pipe (64) is attached to the exterior of the compartment (52).

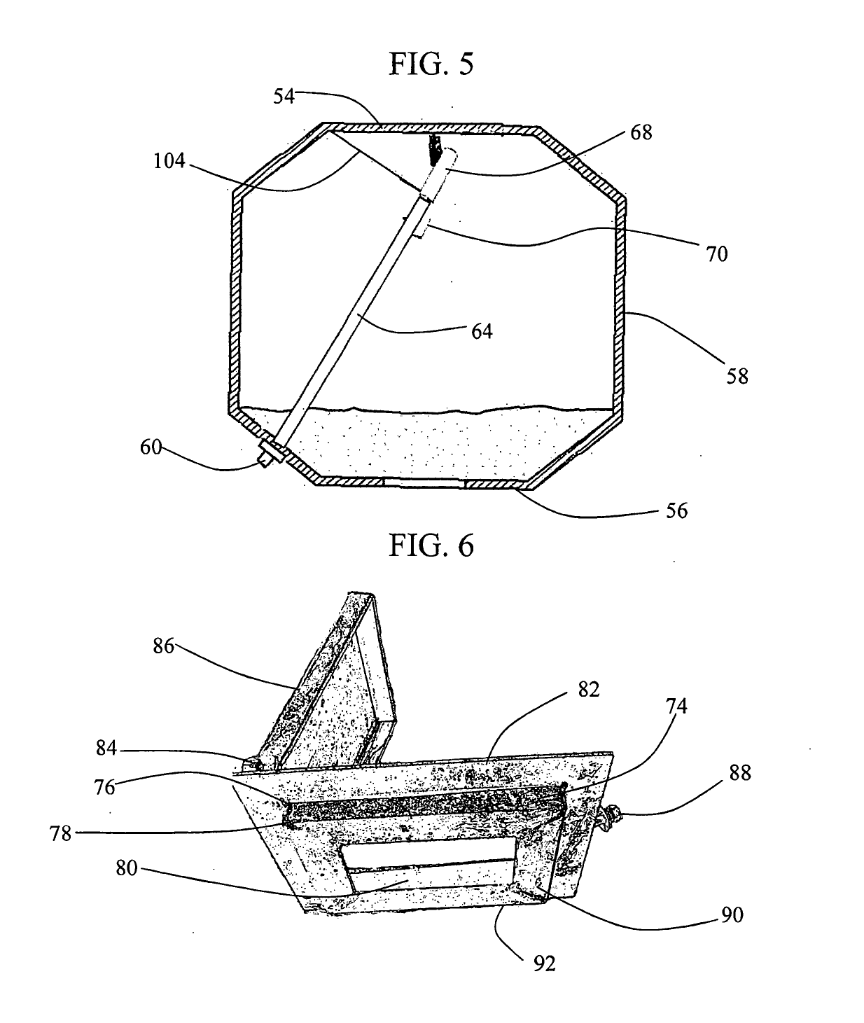

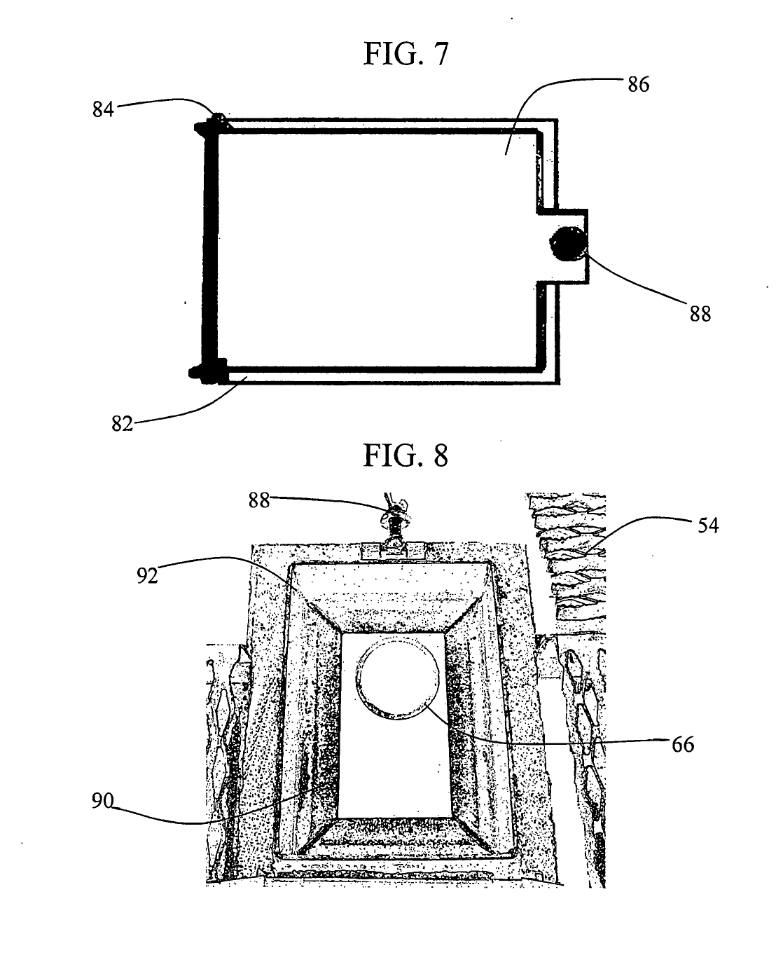

As illustrated in FIG. 4, the lift pipe guide (66) is comprised of an upper cylindrical section (68) and a lower concave section (70). Referring to FIG. 5, the lower concave section (70) is removably attached to the top end of the lift pipe (64). The upper cylindrical section (68) of the lift pipe guide (66) extends above the lift pipe (64) to allow the impact of the proppant (62) to be focused on a precise point on the compartments roof wall (54). To maintain the lift pipe guide (66) in its intended position, one or more positioning straps (104) fixedly attach the lift pipe guide (66) to the interior roof wall (54) of the compartment (52).

To avoid the proppant (62) impacting directly upon the roof wall (54) and to eliminate the need for an individual to enter the compartment (52) and change a wear panel attached to the interior of the roof wall (54), a wear panel housing (72) is installed on the roof wall (54) of the compartment (52).

As illustrated in FIG. 10, the housing (72) is positioned to intrude through an opening on the exterior roof wall (54) of a compartment (52). Referring to FIG. 6, the housing (72) consists of side walls (74), such that each of the side walls (74) has a top edge (76), two side edges (78), and an inward-facing surface (80). The side walls (74) define an interior volume within the roof wall (54).

The mounting lip (82) is located on the top of the housing (72). The top edges (76) of the side walls (74) of the housing (72) are attached to the underside of the mounting lip (82). The underside of the mounting lip (82) is planar for mounting upon the exterior roof wall (54). In the preferred embodiment, hinge mechanisms (84) are located on the upper side of the mounting lip (82) for attaching an openable and closable door (86). On the upper side of the mounting lip (82) but on the side opposite the location the hinge mechanisms (84) is a latch element (88).

The mounting lip (82) is for mounting the apparatus upon the exterior roof wall (54). In the preferred embodiment, the mounting lip (82) is weldedly attached to the exterior roof wall (54). In alternative embodiments, the attachment means may include bolts or glue.

A support plate (90), which is flat and with a shape configured to be located in the plane of the receiving ridge (92) of the housing (72), is attached at its edges to the receiving ridge (92) on the interior walls (74) of the housing (72). The plane of the support plate (90) is, preferably, parallel to the plane of the exterior roof wall (54). The support plate (90) has a rectangular opening (94) to the interior of the compartment (52) for accommodating a wear panel (96).

An openable and securably closable door (86) is mounted on the exterior of the housing (72) to one side of the mounting lip (82). The openable and closable door (86) prevents proppant from escaping the compartment (52) and assists in maintaining the wear panel (96) in its desired location. The door covers a space bounded on the top by the mounting lip (82) that overlies the top edges of the side walls (74), on the sides by the side walls (74) between the receiving ridge and the mounting lip (82), and on the base by the outwardly-facing planar surface of the support plate (90).

The openable and closable door (86) has, optionally, a sealable periphery and the mounting lip (82) has an exterior channel (not shown) for receiving the sealable periphery of the closable door (86). Additionally, the openable and closable door (86) is attached to the exterior of the mounting lip (82) by hinge mechanisms (84). The first side of the hinge mechanism (84) is attached to the mounting lip (82), while the second side of the hinge mechanism (84) is affixed to the side of the openable and closable door (86) opposite the latch mechanism. In the preferred embodiment, the door is held securably closed by a latching mechanism (88).

Removably maintained within the housing (72) is a wear panel (96). The wear panel (96) is flat and with a shape configured to be located in the plane of the receiving ridge (92) of the housing (72). The plane of the wear panel (96) is, preferably, parallel to the plane of the exterior roof wall (54). The wear panel (96), in the preferred embodiment, is constructed of high strength rubber. In alternative embodiments, the wear panel (96) may be constructed of steel or other material capable of withstanding continuous proppant impact.

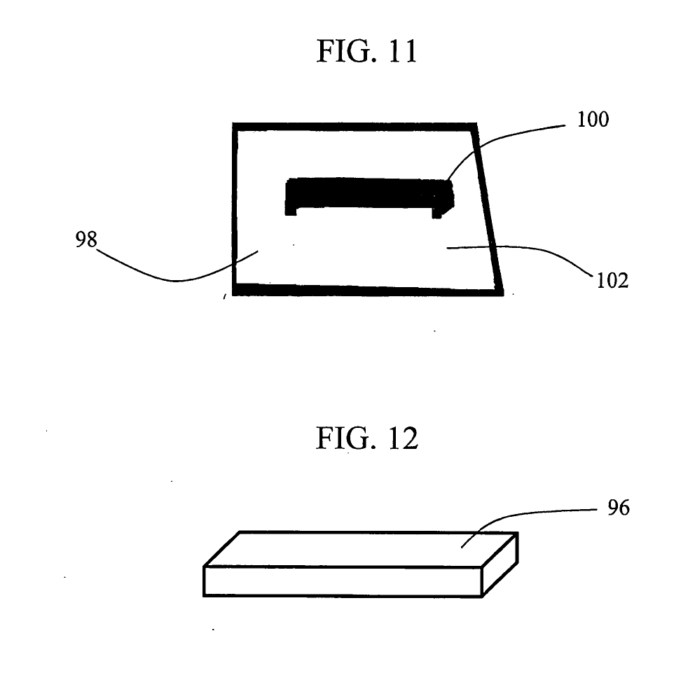

Referring to FIG. 11, the wear panel (96) is maintained in its desired location by means of a pressure plate (98). The pressure plate (98) is flat and with a shape configured to be located in the plane of the receiving ridge (92) of the housing (72). A handle (100) is fixedly attached to the top side (102) of the pressure plate (98). The handle (100) assists in the removal of the pressure plate (98) from the housing (98) and, when the door (86) is in the closed position, makes contact with the interior of the door (86), thereby causing the pressure plate (98) to press downward on the wear panel (96).

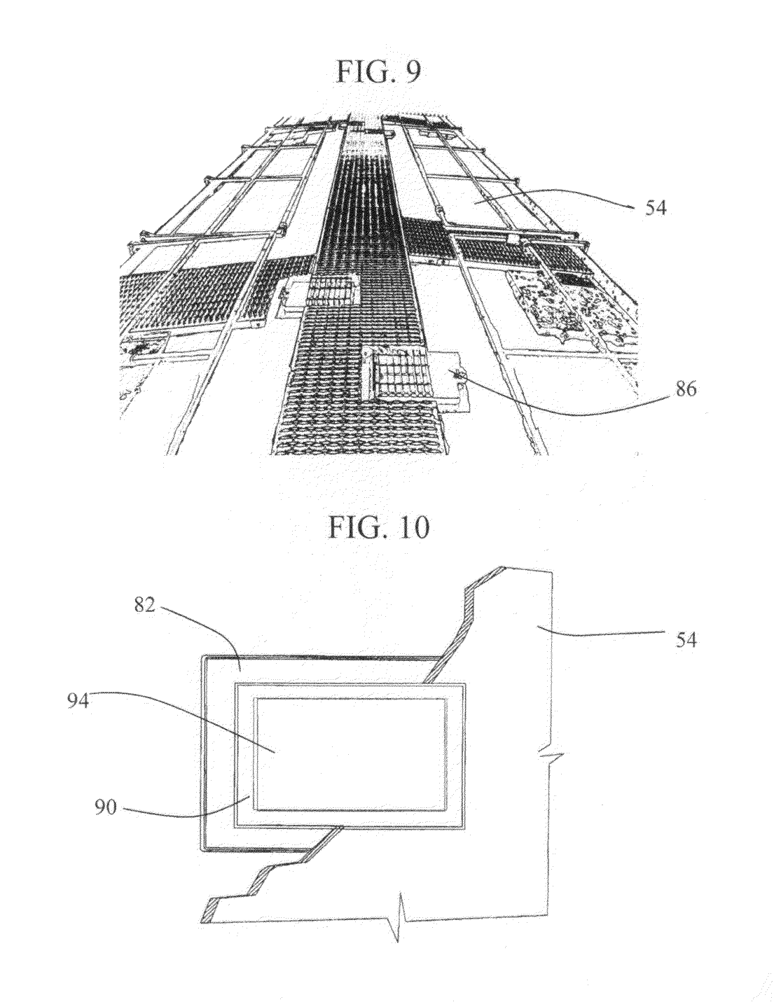

In use, referring to FIG. 9, an individual would access the exterior of the roof wall (54) and proceed to the door (86) of a wear panel housing (72). The latch element (88) is moved to the unlatched position and the door (86) moved to the open position. After opening the door (86), the pressure plate (98) and wear panel (96) are removed. The wear panel (96) is then inspected to determine if it is in need of replacement.

As illustrated in FIG. 8, when the wear panel (96) is removed, the lift pipe guide (66) and lift pipe (64) can be inspected and, if necessary, realigned to insure the proppant comes into contact with the wear panel (96) and not the interior roof wall (54) of the compartment (52). Upon completing the appropriate adjustments of the lift pipe guide (66) and, if necessary, replacement of the wear panel (96), the wear panel (96) and pressure plate (98) are placed upon the support plate (90) of the wear panel housing (72). The door (86) is placed in the closed position and the latch element (88) is moved to the latched position.

This description of the various embodiments of the present invention are presented to illustrate the preferred embodiments of the present invention, and other inventive concepts may be otherwise variously embodied and employed. The description is intended to be construed to include such variations except insofar as limited by the prior art.

What is claimed is:

1. A wear panel housing for a proppant delivery unit compartment, comprising:
a housing
adapted to be positioned through the exterior roof wall of a proppant delivery unit compartment, and having side walls, each of the side walls having a top edge, two side edges, and an inward-facing surface with a receiving ridge parallel to the top edge of the respective each of the side walls, and such that the side edges of each of the side walls are spaced apart and are fixably joined in series such that
the inward-facing surfaces of each of the side walls face inward and define a first space and
the top edge of each of the side walls is joined and forms a first plane and the receiving ridge on each of the side walls forms a second plane, and
having a mounting lip with an exterior surface and a planar underside, for positioning upon the exterior roof wall of the proppant delivery unit compartment, such that the top edge of each side wall, and the first plane formed thereby is fixably joined to the planar underside of the mounting lip, and
a support plate,
shaped to fit within the second plane formed by the receiving ridge on each of the side walls,
with a rectangular opening to the interior of the proppant delivery unit compartment for accommodating a wear panel, and a peripheral edge, so that the peripheral edge of the support plate is affixed to the receiving ridge of the inward-facing surface of each of the side walls of the housing, and
a wear panel,
shaped to fit within the plane of the receiving ridge of the housing,
with the plane of the wear panel parallel to the plane of the exterior roof wall, and
a pressure plate,
shaped to fit within the plane of the receiving ridge of the housing and be removably placed on the wear panel,
having a handle on the top side of said pressure plate.

2. A wear panel housing for a proppant delivery unit compartment as recited in claim 1, wherein the housing is adapted to be positioned upon an exterior surface of the exterior roof wall of a proppant delivery unit compartment.

3. A wear panel housing for a proppant delivery unit compartment as recited in claim 1, further comprising an openable and closable door mounted to the exterior of the housing.

4. A wear panel housing for a proppant delivery unit compartment as recited in claim 3, further comprising a latch mechanism for selectively latching the openable and closable door.

5. A wear panel housing for a proppant delivery unit compartment as recited in claim 3, wherein the openable and closeable door covers the outwardly-facing planar surface of the support plate.

6. A wear panel housing for a proppant delivery unit compartment as recited in claim 3, wherein the openable and closable door has a sealable periphery, and the mounting lip further comprises an exterior channel for receiving at least a portion of the sealable periphery of the openable and closeable door.

7. A wear panel housing for a proppant delivery unit compartment as recited in claim 7, further comprising a hinge mechanism hingedly connecting the openable and closable door to the exterior of the mounting lip.

8. A wear panel housing for a proppant delivery unit compartment as recited in claim 1, further comprising means for permitting the attachment of the housing to the exterior roof wall of the proppant delivery unit compartment.

9. A wear panel housing for a proppant delivery unit compartment as recited in claim 1, wherein the wear panel is constructed of high strength rubber.

10. A lift pipe guide to direct the proper placement of the lift pipe and for directing the proppant to the wear panel during filling of the compartment, comprising:
an upper cylindrical section and a lower concave section with said lower concave section removably attached to the lift pipe and the upper cylindrical section extending to the top end of the lift pipe,
one or more positioning straps fixedly attach the lift pipe guide to the interior roof wall of the proppant delivery unit compartment.

11. A wear panel housing for a proppant delivery unit compartment, comprising:
a housing,
adapted to be positioned through the exterior roof wall of a proppant delivery unit compartment, and
having side walls, each of the side walls having a top edge, two side edges, and an inward-facing surface with a receiving ridge parallel to the top edge of the respective each of the side walls, and such that the side edges of each of the side walls are spaced apart and are fixably joined in series such that
the inward-facing surfaces of each of the side walls face inward and define a first space, and
the top edge of each of the side walls is joined and forms a first plane, and
the receiving ridge on each of the side walls forms a second plane, and
having a mounting lip for positioning upon the exterior roof wall of the proppant delivery unit compartment, such that the top edge of each side wall, and the first plane formed thereby is fixably joined to the planar underside of the mounting lip, and
a support plate,
shaped to fit within the second plane formed by the receiving ridge on each of the side walls,
with a rectangular opening to the interior of the proppant delivery unit compartment for accommodating a wear panel, and a peripheral edge, so that the peripheral edge of the support plate is affixed to the receiving ridge of the inward-facing surface of each of the side walls of the housing, and
an openable and closable door,
with a latching means, mounted to the exterior of the housing to cover the outwardly-facing planar surface of the support plate, and attached to the exterior of the mounting lip by a hinge mechanism, and
a wear panel,
shaped to fit within the plane of the receiving ridge of the housing, with the plane of the wear panel parallel to the plane of the exterior roof wall,
constructed of high strength rubber, and
a pressure plate,
shaped to fit within the plane of the receiving ridge of the housing and be removably placed on the wear panel,
having a handle on the top side of said pressure plate.
